(19) United States
(12) Patent Application Publication
(10) Pub. No.: US 2011/0067419 A1
(43) Pub. Date: Mar. 24, 2011

(54) AIR-CONDITIONING CONTROL DEVICE FOR VEHICLE

(75) Inventor: Takeshi Aoyagi, Toyota-city (JP)

(73) Assignee: DENSO CORPORAITON, Kariya-city (JP)

(21) Appl. No.: 12/872,720

(22) Filed: Aug. 31, 2010

(30) Foreign Application Priority Data
Sep. 24, 2009 (JP) 2009-218971

(51) Int. Cl. B60H 1/32; F25B 49/00

(52) U.S. Cl. 62/133; 62/228.1

(57) ABSTRACT

An air-conditioning control device for a vehicle includes an air-conditioner, an estimating portion, and a controller. The air-conditioner includes a compressor driven by an engine of the vehicle so as to compress refrigerant, and a heat storage portion having a coolness storage agent to store heat of the refrigerant. A passenger compartment of the vehicle is air-conditioned using air cooled by the heat storage portion when the compressor is stopped. The estimating portion estimates a present value of coolness amount stored in the heat storage portion based on a temperature history of the refrigerant. The controller controls the compressor based on the estimated present value of coolness amount.

### CROSS REFERENCE TO RELATED APPLICATION

This application is based on Japanese Patent Application No. 2009-218971 filed on Sep. 24, 2009, the disclosure of which is incorporated herein by reference in its entirety.

### BACKGROUND OF THE INVENTION

1. Field of the Invention

The present invention relates to an air-conditioning control device for a vehicle.

2. Description of Related Art

JP-A-2003-175721 discloses an air-conditioning device for a vehicle. The air-conditioning device has a refrigerating cycle, and a compressor of the cycle is driven by an engine of the vehicle. The air-conditioning device further has a heat storage portion to store heat of refrigerant, and the stored heat is used for an air-conditioning of a passenger compartment of the vehicle. While the engine is stopped, the compressor cannot be activated by the engine. However, the air-conditioning of the passenger compartment can be performed using the stored heat. Thus, the passenger compartment can be made more comfortable while the compressor is stopped.

JP-A-2009-012721 discloses an air-conditioning device, in which a compressor is controlled based on an amount of coolness stored in a storage portion. Therefore, a fuel consumption amount can be restricted from increasing, and fuel expense can be restricted from increasing.

However, the coolness amount stored in the storage portion cannot be accurately detected. If an estimation value of the coolness amount is lower than an actual value, the compressor may be too much activated. In this case, the fuel expense of the engine may be increased. Further, heat required for an air-conditioning may not be accurately estimated when the compressor is stopped. In this case, if the coolness amount becomes too much, the fuel expense of the engine may be increased.

### SUMMARY OF THE INVENTION

In view of the foregoing and other problems, it is an object of the present invention to provide an air-conditioning control device for a vehicle.

According to a first example of the present invention, an air-conditioning control device for a vehicle includes an air-conditioner, an estimating portion, and a controller. The air-conditioner includes a compressor driven by an engine of the vehicle so as to compress refrigerant, and a heat storage portion having a coolness storage agent so as to store heat of the refrigerant. A passenger compartment of the vehicle is air-conditioned using air cooled by the heat storage portion when the compressor is stopped. The estimating portion estimates a present value of coolness amount stored in the heat storage portion based on a temperature history of the refrigerant. The controller controls the compressor so as to store coolness in the heat storage portion based on the estimated present value of coolness amount stored in the heat storage portion.

Accordingly, the fuel consumption amount can be reduced.

According to a second example of the present invention, an air-conditioning control device includes an air-conditioner, a predicting portion, a target coolness amount setting portion, and a controller. The air-conditioner includes a compressor driven by an engine of the vehicle so as to compress refrigerant, the compressor being, and a heat storage portion having a coolness storage agent so as to store heat of the refrigerant. A passenger compartment of the vehicle is air-conditioned using air cooled by the heat storage portion when the compressor is stopped. The predicting portion predicts an increase value of coolness amount stored in the heat storage portion when the coolness amount is increased by converting a kinetic energy of the vehicle when the vehicle has a slowdown. The target coolness amount setting portion sets a target value of the coolness amount stored in the heat storage portion by subtracting the predicted increase value from a heat amount required for performing air-conditioning of the passenger compartment when the compressor is stopped. The controller controls the compressor based on the target value, and causes the compressor to be driven when the vehicle has the slowdown.

Accordingly, the fuel consumption amount can be reduced.

According to a third example of the present invention, an air-conditioning control device for a vehicle includes an air-conditioner, an allowable amount setting portion, and a controller. The air-conditioner includes a compressor driven by an engine of the vehicle so as to compress refrigerant, and a heat storage portion having a coolness storage agent so as to store heat of the refrigerant. A passenger compartment of the vehicle is air-conditioned using air cooled by the heat storage portion when the compressor is stopped. The allowable amount setting portion sets an allowable amount of a fuel consumption for heat, the fuel consumption for heat corresponding to a fuel consumption amount of the engine required for generating a predetermined heat amount by driving the compressor. The controller drives the compressor if the fuel consumption for heat is equal to or lower than the allowable amount.

Accordingly, the fuel consumption amount can be reduced.

### BRIEF DESCRIPTION OF THE DRAWINGS

The above and other objects, features and advantages of the present invention will become more apparent from the following detailed description made with reference to the accompanying drawings. In the drawings:

FIG. 1 is a schematic view illustrating an air-conditioning device according to an embodiment;

FIG. 2 is a block diagram illustrating a process to control a compressor of the air-conditioning device;

FIG. 3 is a block diagram illustrating a process to calculate a target coolness amount stored in a coolness storage portion of the air-conditioning device;

FIG. 4 is a diagram illustrating a process to calculate a present value of coolness amount stored in the coolness storage amount;

FIG. 5 is a diagram illustrating a process to calculate an upper limit for a fuel consumption for heat;

FIG. 6 is a map illustrating a fuel consumption rate defined for an engine of a vehicle having the air-conditioning device;

FIG. 7 is a diagram illustrating a process to calculate a target torque of the compressor; and

FIG. 8 is a flowchart illustrating a process to control the fuel consumption for heat.

### DETAILED DESCRIPTION OF PREFERRED EMBODIMENT

An air-conditioning device of an embodiment is used for a vehicle, for example.

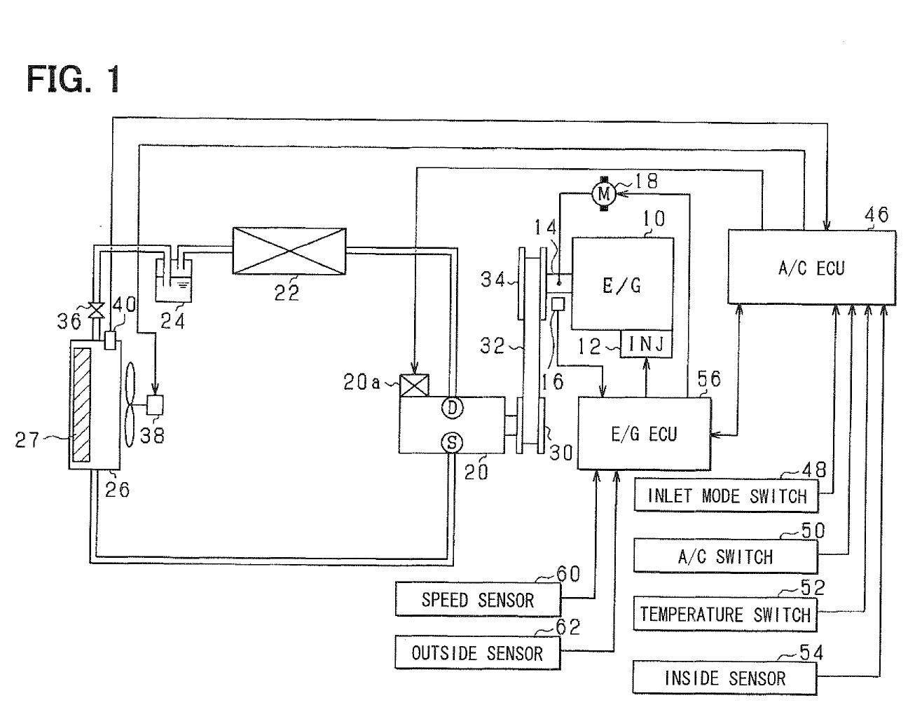

FIG. 1 illustrates an engine system and an air-conditioning system of the vehicle.

An engine 10 of the vehicle is a spark ignition type internal combustion engine. Each cylinder of the engine 10 has a fuel injection valve 12 and a ignition plug (not shown). The valve 12 supplies fuel for a combustion chamber of the engine 10. The plug generates discharge spark for combusting air-fuel mixture. Energy generated by the combustion of fuel is taken out as rotating power from an output crankshaft 14 of the engine 10.

A crank angle sensor 16 is arranged adjacent to the crankshaft 14 so as to detect rotation angle of the crankshaft 14. The engine 10 is not limited to the spark ignition type engine such as gasoline engine. For example, the engine 10 may be a compression ignition type engine such as diesel engine.

A starter 18 is connected to the crankshaft 14, and is activated to give initial rotation to the crankshaft 14 when an ignition switch (not shown) is turned on. Thus, the engine 10 is activated.

The air-conditioning system has a compressor 20, a condenser 22, a receiver 24, and an evaporator 26. The compressor 20 draws and discharges refrigerant so as to make the refrigerant to circulate in a refrigerating cycle.

A refrigerant discharge capacity of the compressor 20 is variable by operating an electromagnetic control valve 20a (CV) of the compressor 20. A compressor pulley 30 is mechanically connected to a drive shaft of the compressor 20, and is mechanically connected to the crankshaft 14 through a belt 32 and a crank pulley 34.

While the rotating power of the crankshaft 14 is transmitted to the compressor 20, the discharge capacity of the compressor 20 is controlled by changing electricity supplied to the control valve 20a. The compressor 20 is driven when the discharge capacity is larger than 0. The compressor 20 is stopped when the discharge capacity becomes equal to 0.

Heat is exchanged in the condenser 22 between air sent from a fan (not shown) and refrigerant flowing out of the compressor 20. The fan is driven by a DC motor, for example. The receiver 24 separates refrigerant flowing out of the condenser 22 into gas phase and liquid phase, and temporally stores the liquid phase refrigerant. Only liquid phase refrigerant flows downstream of the receiver 24.

The liquid phase refrigerant is rapidly expanded by a temperature expansion valve 36 so as to have mist form. The mist form refrigerant is supplied to the evaporator 26 to cool air to be sent into a passenger compartment of the vehicle. Air sent from an evaporator fan 38 and the mist form refrigerant exchange heat in the evaporator 26. The fan 38 is driven by a DC motor, for example.

Therefore, a part or all of refrigerant is evaporated, such that outside air or inside air sent from the evaporator fan 38 is cooled. The cooled air is sent into the passenger compartment through a port (not shown). Thus, the passenger compartment can be cooled.

The evaporator 26 includes a coolness storage agent 27 made of paraffin, for example. The evaporator 26 is used as a heat storage portion to store heat of refrigerant. The heat storage portion is used for cooling the passenger compartment, while the engine 10 is automatically stopped by an idle stop control to be mentioned later.

Specifically, heat is exchanged between the coolness storage agent 27 and refrigerant supplied to the evaporator 26 from the compressor 20. Thus, heat of refrigerant is stored in the evaporator 26. When the compressor 20 is stopped, heat is exchanged between the coolness storage agent 27 and air sent from the evaporator fan 38. Therefore, the air is cooled, and the cooled air is sent into the passenger compartment through the port. Thus, the passenger compartment can be cooled even when the engine 10 is automatically stopped.

A refrigerant temperature sensor 40 is arranged just at an inlet of the evaporator 26, and detects refrigerant temperature. Refrigerant flowing out of the evaporator 26 is drawn into the compressor 20.

The air-conditioning system is controlled by an air-conditioning ECU 46 including a microcomputer having CPU, ROM and RAM. Signals are input into the ECU 46 from switches and sensors. An inlet mode switch 48 is operated to select an air inlet mode between inside mode and outside mode. Outside air is introduced in the outside mode, and inside air is circulated in the inside mode. An air-conditioning switch 50 is turned on so as to activate the compressor 20 when a cooling of the passenger compartment is required. A target temperature is set for the passenger compartment by operating a target temperature switch 52. An inside sensor 54 detects a temperature of air inside of the passenger compartment. Further, signal is input into the ECU 46 from the refrigerant temperature sensor 40.

The ECU 46 controls the evaporator fan 38 and the control valve 20a by performing control program memorized in the ROM in response to the input signals. Therefore, the compressor 20 is controlled, and the passenger compartment can be cooled.

While the engine 10 is automatically stopped, a temperature of air supplied to the passenger compartment is controlled not to be raised from a predetermined temperature such as 15° C. by a predetermined value such as 3° C. The predetermined temperature is set based on a target temperature such as 25° C. calculated by using an output of the switch 52.

The engine system is controlled by an engine ECU 56 including a microcomputer having CPU, ROM and RAM. Signals are input into the ECU 56 from a speed sensor 60 to detect a speed of the vehicle, an outside air sensor 62 to detect an outside air temperature, and the crank angle sensor 16. Information is exchanged between the ECUs 56, 46 in both directions. A signal of the NC switch 50 is output from the air-conditioning ECU 46 into the engine ECU 56. Signals of the sensors 16, 60, 62 are input into the air-conditioning ECU 46 from the engine ECU 56.

The engine ECU 56 executes control program memorized in the ROM in response to the input signals, so as to control the fuel injection valve 12 and the starter 18 of the engine 10. Further, the engine ECU 56 performs idle stop control of the engine 10. Due to the idle stop control, the engine 10 is automatically stopped when a predetermined condition is satisfied while the engine 10 is active, and the engine 10 is restarted when a predetermined condition is satisfied. Therefore, a fuel consumption amount of the engine 10 can be reduced.

A fuel expense control performed by the air-conditioning ECU 46 will be described. Due to the fuel expense control, heat amount stored in the agent 27 of the evaporator 26 can be restricted from becoming insufficient when the engine 10 is automatically stopped. Further, the fuel consumption amount of the engine 10 can be restricted from increasing even if the compressor 20 is activated for a coolness storage operation.

First, a target value is set for the coolness storage amount in the evaporator 26 based on an estimated load of air-conditioning. The load of air-conditioning is generated while the engine 10 is automatically stopped. Further, a present value is estimated for the coolness storage amount in the evaporator 26.

Next, when the refrigerating cycle is activated by the compressor 20, a fuel consumption amount of the engine 10 necessary for generating a predetermined heat amount is estimated. Further, an upper limit is set for the fuel consumption amount based on the present value and the target value of the coolness storage amount. The fuel consumption amount may be defined as a fuel expense.

The compressor 20 is activated only when the estimated fuel consumption amount is equal to or lower than the upper limit. Therefore, the evaporator 26 can have proper coolness storage amount while the engine 10 is automatically stopped. Further, the fuel consumption amount of the engine 10 can be reduced. The fuel expense control will be specifically described by separating into six processes.

### 1. A Process for Controlling the Compressor 20

The compressor 20 is controlled only when the A/C switch 50 is on. Electricity is supplied to the control valve 20a in a manner that a present time actual torque of the compressor 20 becomes equal to a target torque of the compressor 20. The target torque is set in a target torque calculation process to be described below. The torque is controlled using a feed-forward control and a feed-back control. Thus, both of responsivity and followability of the torque of the compressor 20 are improved.

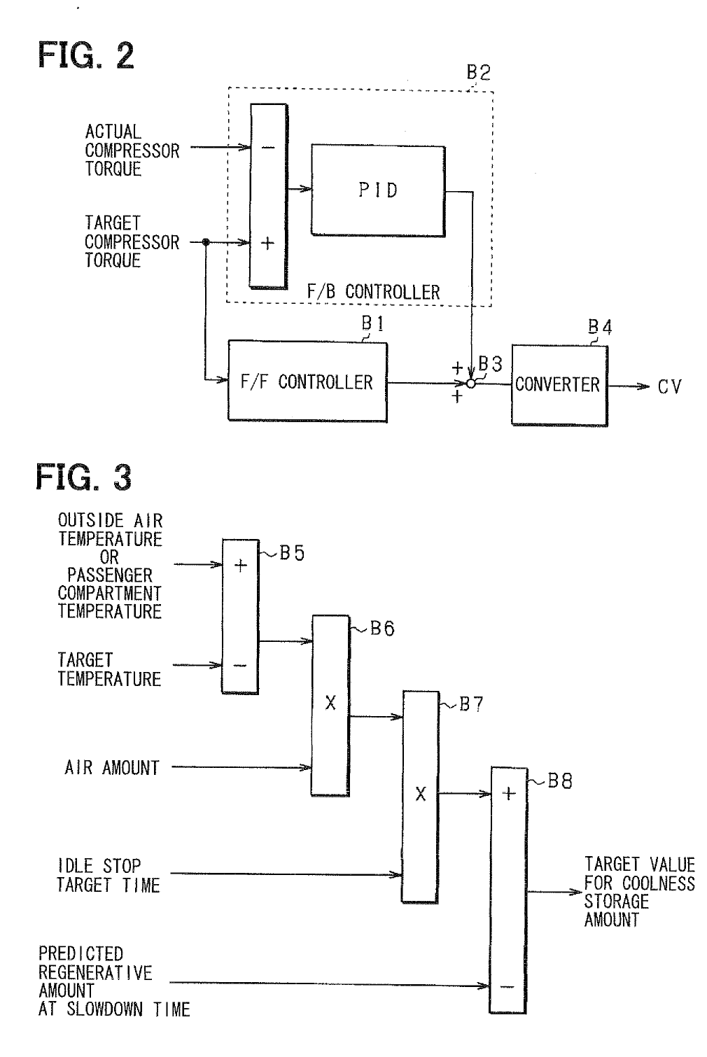

FIG. 2 illustrates a block diagram of the control process of the compressor 20.

A feed-forward controller B1 computes a feed-forward operation amount of the control valve 20a in accordance with the target compressor torque.

A feed-back controller B2 computes a deviation of the actual compressor torque and the target compressor torque, and computes a feed-back operation amount of the control valve 20a based on the deviation. The feed-back operation amount is computed using proportional integration differentiation (PID) control, for example.

The actual compressor torque may be calculated using an output value of the crank angle sensor 16 representing an engine rotation speed, an output value of the speed sensor 60 representing a speed of the vehicle, an output value of the outside air sensor 62 representing an outside air temperature, and an output value of a pressure sensor (not shown) representing a refrigerant pressure. The pressure sensor detects a pressure of refrigerant flowing between the receiver 24 and the expansion valve 36.

An addition part B3 adds the feed-forward operation amount and the feed-back operation amount with each other. An output of the addition part B3 represents the discharge capacity of the compressor 20.

A drive current conversion part B4 converts the discharge capacity into a drive current value of the control valve 20a, and converts the drive current value into a duty value. The duty value is defined by a ratio of ON time relative to an ON/OFF period. The drive current value is adjusted by controlling the duty value. Thus, the compressor torque can be made closer to the target value.

### 2. A Process for Calculating a Target Value of Coolness Storage Amount

The process for calculating a target value of coolness storage amount will be described with reference to FIG. 3.

A temperature difference calculator B5 computes a temperature difference between an actual value of the passenger compartment or the outside air, and a target value. If it is determined that the inside mode is selected based on an output value of the switch 48, the actual value of the passenger compartment is used. If it is determined that the outside mode is selected, the actual value of the outside air is used.

A load calculator B6 estimates a cooling load of the passenger compartment by multiplying the temperature difference by an air amount sent by the evaporator fan 38, while the engine 10 is automatically stopped.

A basic target value calculator B7 calculates a basic target value of coolness storage amount of the evaporator 26 by multiplying the cooling load by an idle stop standard time such as 60 seconds. The engine 10 is automatically stopped by the idle stop control when the idle stop standard time is elapsed.

Therefore, the coolness storage amount of the evaporator 26 required for a cooling operation can be calculated with high precision while the engine 10 is automatically stopped. The idle stop standard time may be set in advance based on a usual automatic-stop time of the engine 10 when the vehicle is driving in an urban area, for example.

A final target value calculator B8 calculates a final target value of coolness storage amount of the evaporator 26 by subtracting a regenerative amount from the basic target amount. The regenerative amount is a prediction value for an increase of the coolness storage amount, and is generated when the vehicle has a slowdown. The coolness storage amount is increased by changing a kinetic energy of the vehicle into an energy for driving the compressor 20, when the kinetic energy of the vehicle is decreased by a brake operation. Therefore, the fuel consumption amount used for the coolness storage operation can be reduced. Thus, the fuel consumption amount of the engine 10 can be restricted from increasing.

Specifically, the regenerative amount is computed by multiplying the kinetic energy of the vehicle by a regeneration rate. The kinetic energy is computed using speed and weight of the vehicle The regeneration rate is estimated as a rate of energy able to be used for driving the compressor 20 to the kinetic energy of the vehicle at the slowdown time. The regeneration rate may be computed by incorporating a parameter such as speed of the vehicle into a predetermined map. For example, the map is predetermined based on experiment results, and a decreasing of the kinetic energy of the vehicle generated by a usual brake operation is obtained in experiments.

The discharge capacity of the compressor 20 may be controlled to become equal to the maximum capacity (100%) at a slowdown time. In this case, the coolness storage amount of the evaporator 26 can be increased, before a decreasing amount of the kinetic energy of the vehicle is increased by the brake operation.

### 3. A Process for Estimating a Present Value of Coolness Storage Amount

A present value of coolness storage amount is estimated based on a refrigerant flowing amount, a refrigerant temperature history, and a phase of the agent 27. The phase of the agent 27 is detected based on the coolness storage amount of the evaporator 26 and a temperature of the agent 27. Thus, the present value of coolness storage amount can be accurately estimated.

The coolness storage amount of the evaporator 26 is changed by heat exchange between the agent 27 and refrigerant. While a phase transition is generated between a liquid phase and a solid phase, the temperature of the agent 27 is not changed, because the coolness storage amount is changed by latent heat. For this reason, if the coolness storage amount is estimated only from the temperature or specific heat of the agent 27, estimation accuracy may be low in a comparison example.

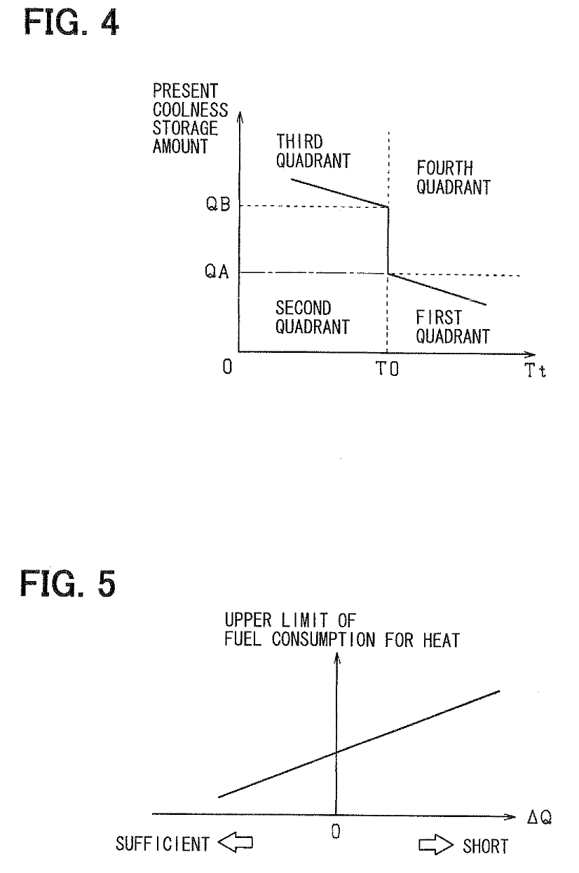

In contrast, according to the embodiment, the phase of the agent 27 is detected, and the agent 27 is selectively estimated to have sensible heat or latent heat. Therefore, the change of the coolness storage amount can be determined to be generated by the sensible heat or the latent heat. Thus, the present value of coolness storage amount can be accurately estimated. The estimation method of the present value of coolness storage amount will be described with reference to FIG. 4.

### (A) First Quadrant

In a first quadrant, a temperature Tt of the agent 27 is higher than a freezing point T0 such as about 16° C. Further, the coolness storage amount of the evaporator 26 is smaller than a first amount QA at which the agent 27 begins to solidify. For this reason, a variation of the coolness storage amount of the evaporator 26 per unit time is mainly based on the sensible heat of the agent 27. Therefore, the present value of coolness storage amount can be calculated by using the following formula (1).

$$\begin{matrix}present value = last time value + variation amount \\ = last time value + β \times K \times A \times ( Tt - Tf ) \times Δ t\end{matrix} \qquad ( 1 )$$

(Tt>T0, last time value<QA)
β: a predetermined coefficient set between 0-1 in accordance with the refrigerant flowing amount
A [m̂2]: a heat transmission area between refrigerant and the agent 27
Tt [K]: a temperature of the agent 27
Tf [K]: refrigerant temperature
Δt [s]: a calculation period of the air-conditioning ECU 46
K [kJ/(m̂2·s·K)]: a heat passing rate between refrigerant and the agent 27=1/{(1/αf)+(dm/λm)+(1/αt)}
αf [kJ/(m̂2·s·K)]: a heat transmission rate between refrigerant and a wall surface of the evaporator 26
λm [kJ/(m·s·K)]: a heat conductivity of the wall surface of the evaporator 26
dm [m]: a wall thickness of the evaporator 26
αt [kJ/(m̂2·s·K)]: a heat transmission rate between the wall surface of the evaporator 26 and the agent 27

The wall surface of the evaporator 26 represents a component of the evaporator 26 to separate the refrigerant and the agent 27.

The agent 27 starts to solidify at the first amount QA[kJ], and the first amount QA is predetermined by using experiment results. The temperature of the agent 27 may be estimated by dividing a last time coolness amount by a product of a specific heat c1 and a mass M of the agent 27. The heat transmission rate at defined between the wall surface of the evaporator 26 and the agent 27 may be changed based on the phase (liquid or solid) of the agent 27. Thus, the estimation accuracy of the coolness storage amount can be further increased.

The coefficient β is set based on the refrigerant flowing amount, such that variation amount can be presumed with high precision. If the refrigerant flowing amount is small, a rising degree of refrigerant temperature is increased by heat exchange between the agent 27 and refrigerant. At this time, the actual refrigerant temperature may become higher than the refrigerant temperature detected by the sensor 40. In this comparison example, the estimation accuracy of the variation amount is lowered.

In contrast, according to the present embodiment, because the rising degree of refrigerant temperature depends on the refrigerant flowing amount, the rising degree of refrigerant temperature is corrected by the coefficient β. Thus, the estimation accuracy of the variation amount can be raised.

Specifically, the coefficient β is set as 1 when the rising degree of the refrigerant temperature can be disregarded. The coefficient β is set closer to 0 as the refrigerant flowing amount is reduced. The refrigerant flowing amount can be calculated based on the engine rotation speed and the actual discharge capacity of the compressor 20.

The last time coolness storage amount represents a last time value of the present coolness amount. When the estimation process of the coolness storage amount is started, the present coolness amount may be calculated by multiplying the specific heat c1 [kJ/(kg·k)] of the liquid phase agent 27, the mass M [kg] of the agent 27, and the refrigerant temperature.

At this time, generally, the temperature of the agent 27 is high because the vehicle is left for a long time before the process is started. Therefore, the agent 27 has the liquid phase, and the temperature of the agent 27 is approximately equal to the refrigerant temperature. That is, the latent heat of the agent 27 is ignorable.

### (B) Second Quadrant

In a second quadrant, the temperature of the agent 27 corresponds to the freezing point T0 representing a phase transition temperature. Further, the coolness storage amount of the evaporator 26 is smaller than a second amount QB(>QA) at which the agent 27 completely solidifies. In this case, freezing of the agent 27 advances gradually from a heat-transmitting surface of the evaporator 26, because heat is transmitted from the liquid phase agent 27 to refrigerant. Therefore, a variation of coolness amount stored in the evaporator 26 is mainly based on the latent heat of the agent 27. Therefore, the present value of coolness storage amount can be calculated by using the following formula (2).

$$\begin{matrix}Present value = last time value + variation amount \\ = last time value + β \times K \times A \times ( T 0 - Tf ) \times Δ t\end{matrix} \qquad ( 2 )$$

(Tt=T0, QA≦last time value≦QB)
   K=1/{(1/αf)+(dm/λm)+(1/αt)+(dt/λt)}
   λt [kJ/(m·s·K)]: a heat conductivity of the agent 27 from a heat-transmitting surface between the evaporator 26 and the agent 27 to a face of the agent 27 having the phase transition
   dt [m]: a thickness of the agent 27 to the face of the agent 27 having the phase transition

In the formula (2), the variation amount of coolness storage is estimated by incorporating the phase transition of the agent 27. That is, the heat passing rate K is set by incorporating the heat conductivity λt and the thickness dt of the agent 27. Thus, the estimation accuracy of the coolness storage amount can be further increased. The heat conductivity λt and the thickness dt of the agent 27 may be calculated based on the last time coolness storage amount and the temperature of the agent 27. The second amount QB may be predetermined by using experiment results.

### (C) Third Quadrant

In a third quadrant, the temperature of the agent 27 is lower than a melting point T0. Further, the coolness storage amount of the evaporator 26 is equal to or larger than the second amount QB at which the agent 27 completely solidifies. For this reason, the variation amount of the agent 27 is mainly based on the sensible heat of the agent 27. Therefore, the present coolness storage amount can be calculated by using the formula (1). At this time, a condition of Tt<T0 is satisfied, and the last time storage amount is equal to or larger than the second amount QB. The temperature of the agent 27 may be estimated by dividing the last time storage amount by a product of a specific heat c2[kJ/(kg·K)] of the agent 27 and a mass M of the agent 27.

### (D) Fourth Quadrant

In a fourth quadrant, the temperature of the agent 27 corresponds to the melting point T0 representing a phase transition temperature. Further, the coolness storage amount of the evaporator 26 is larger than the first amount QA at which the agent 27 is completely melted. In this case, the melting of the agent 27 advances gradually from a heat-transmitting surface of the evaporator 26, because heat is transmitted from refrigerant to the solid phase agent 27. For this reason, the variation amount of the agent 27 is mainly based on the latent heat of the agent 27. Therefore, the present coolness storage amount can be calculated by using the formula (2).

### 4. A Process for Calculating an Upper Limit of Fuel Consumption for Heat

As shown in FIG. 5, an upper limit of fuel consumption for heat is computed as a proportional term by multiplying a required coolness amount ΔQ by a predetermined positive number. The positive number corresponds to a proportional gain. The required coolness amount ΔQ is calculated by subtracting the present coolness storage amount from the target coolness storage amount. Thus, a shortage degree of the coolness amount required for a cooling operation can be accurately estimated when the engine 10 is automatically stopped. If the shortage degree is increased, a refrigerant sending amount of the compressor 20 is suitably increased.

The upper limit of fuel consumption for heat may be calculated by adding an integral term or a derivative term to the proportional term. The integral term may be output when the required coolness amount ΔQ is input into an integral element. The derivative term may be output when the required coolness amount ΔQ is input into a derivative element.

If both of the integral term and the derivative term are not used in a comparison example, steady deviation may arise between the target amount and the actual amount. In this comparison example, the coolness amount stored in the evaporator 26 may have a shortage while the engine 10 is automatically stopped by the idle stop control. Therefore, a temperature of air blow toward the passenger compartment may be extremely increased than a temperature predetermined based on the target temperature, in the comparison example.

If the integral term is added, the upper limit is increased, and the steady deviation is decreased. Therefore, the refrigerant sending amount of the compressor 20 can be increased while the coolness storing is performed. Thus, the coolness amount necessary when the engine 10 is automatically stopped can be secured, such that the temperature of air blow toward the passenger compartment may be restricted from increasing.

However, while the coolness storing is performed by the evaporator 26, a speed for storing the coolness amount may be too fast. At this time, the present coolness storage amount may become larger than the target coolness storage amount, such that a temperature of air blow toward the passenger compartment may be extremely lowered than the temperature predetermined based on the target temperature when the engine 10 is automatically stopped. In this case, if the derivative term is added, the upper limit is lowered, and excess coolness storage can be reduced. Thus, the temperature of air blow toward the passenger compartment can be restricted from being extremely lowered.

### 5. A Process for Estimating Fuel Consumption for Heat

An estimation fuel consumption for heat can be expressed by the following formula (3).

Estimation fuel consumption for heat [g/Wh]=required fuel consumption amount [g/h]/{power [W] for driving compressor having torque T×COP} (3)

A denominator of formula (3) is a heat amount generated by the refrigerating cycle when the compressor 20 has a torque of T(>0). In formula (3), the power for driving the compressor 20 may be calculated as a product of the torque T and the engine rotation speed. A coefficient-of-performance COP is a parameter which changes the power for driving the compressor 20 into a heat amount.

The coefficient-of-performance COP may be set by using a map. For example, the air temperature of the passenger compartment, the outside air temperature, the target temperature, and the engine rotation speed are used as input parameter of the map.

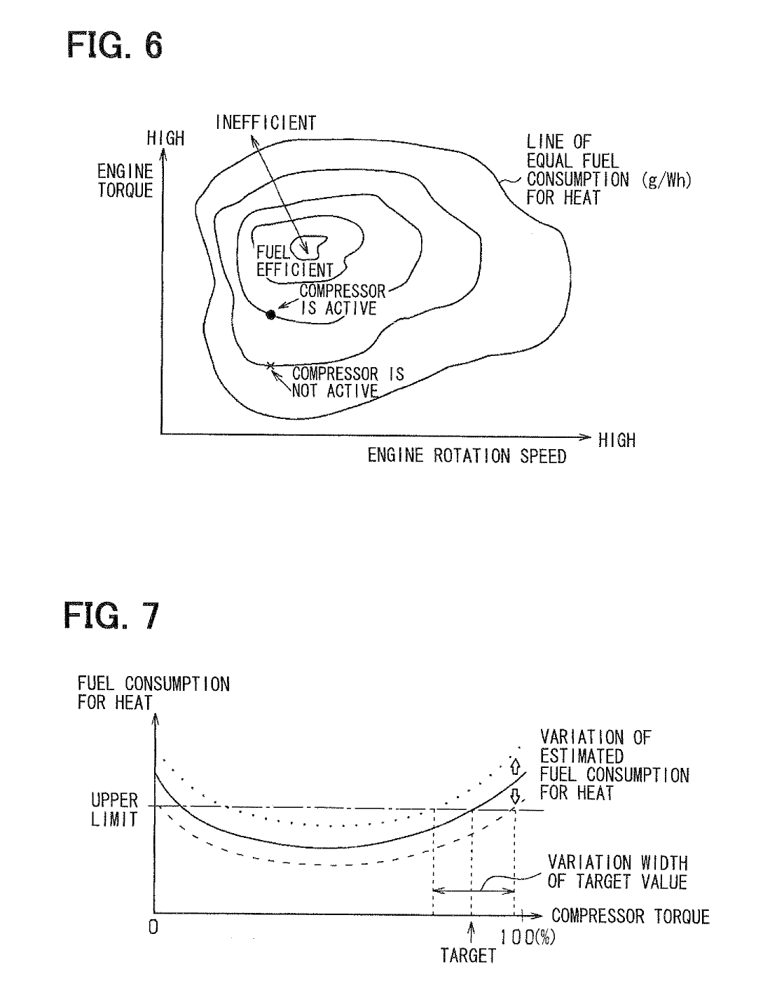

A numerator of formula (3) is an increasing of the fuel consumption amount of the engine 10 in response to the driving of the compressor 20. The numerator is computable using a map of FIG. 6 in which a fuel consumption rate is expressed in relation with the torque of the engine 10 and the rotation speed of the engine 10.

Specifically, the fuel consumption rate is calculated based on the map using the torque and the rotation speed. The calculation is performed relative to a case where the compressor 20 is active, and is performed relative to a case where the compressor 20 is not active.

Each fuel consumption rate is multiplied by an engine power corresponding to a product of the torque and the rotation speed. Thus, a first fuel consumption amount of the engine 10 is defined relative to torque 0, that is when the compressor 20 is not active, and is represented by a symbol x of FIG. 6. Further, a second fuel consumption amount of the engine 10 is defined relative to torque T, that is when the compressor 20 is active, and is represented by a symbol of FIG. 6.

A difference between the first and second fuel consumption amounts is calculated as the required fuel consumption amount. Therefore, the required fuel consumption amount can be expressed by the following formula (4).

Required fuel consumption amount [g/h]=second fuel consumption amount−first fuel consumption amount (4)

Formula (5) is obtained by incorporating formula (4) into formula (3). Due to formula (5), the fuel consumption for heat can be estimated.

Estimation fuel consumption for heat [g/Wh]32 {(second fuel consumption amount−first fuel consumption amount)[g/h]}/{power [W] for driving compressor having torque T×COP} (5)

### 6. A Process for Calculating a Target Torque of Compressor

A target torque of compressor is calculated based on the upper limit of fuel consumption for heat and the estimation fuel consumption for heat.

FIG. 7 illustrates examples of the upper limit of fuel consumption for heat and the estimation fuel consumption for heat calculated in the above process. A linear alternate long and short dash line of FIG. 7 represents the upper limit of fuel consumption for heat, and a continuous line of FIG. 7 represents the estimation fuel consumption for heat. A horizontal axis of FIG. 7 represents the torque of the compressor. The torque of the compressor is defined as 100% when the compressor 20 discharges refrigerant at its maximum capacity.

The estimation fuel consumption for heat is calculated by defining the compressor torque to have plural values different from each other by using formula (5). The maximum value of the compressor torque is defined as a target compressor torque in a manner that the estimation fuel consumption for heat becomes equal to or lower than the upper limit.

Therefore, the fuel consumption amount of the engine 10 is restricted from increasing, even if the compressor 20 is driven by the engine 10. Further, the refrigerant sending amount can be increased considering the shortage degree. Thus, the coolness storing can be rapidly performed in the evaporator 26.

A variation of the target compressor torque has a fixed-width dead zone, such as ±5% relative to the calculated target compressor torque. The dead zone represents a lower limit of variation between the last time target torque and the present time target torque.

Therefore, the present time target torque becomes equal to the last time target torque, or is changed by the width of the dead zone or more. As shown in a dot line and a broken line of FIG. 7, the target torque is restricted from being varied even if the estimation fuel consumption for heat is varied.

In a comparison example, if the estimation fuel consumption for heat is varied in accordance with operation state change of the engine 10, the target torque is varied, thereby the actual torque may be varied. In this comparison example, even if an accelerator operation amount is constant, for example, the torque of the engine 10 is varied, such that drivability may be lowered.

However, due to the dead zone of the present embodiment, the actual torque can be restricted from being varied, such that the drivability can be restricted from being lowered.

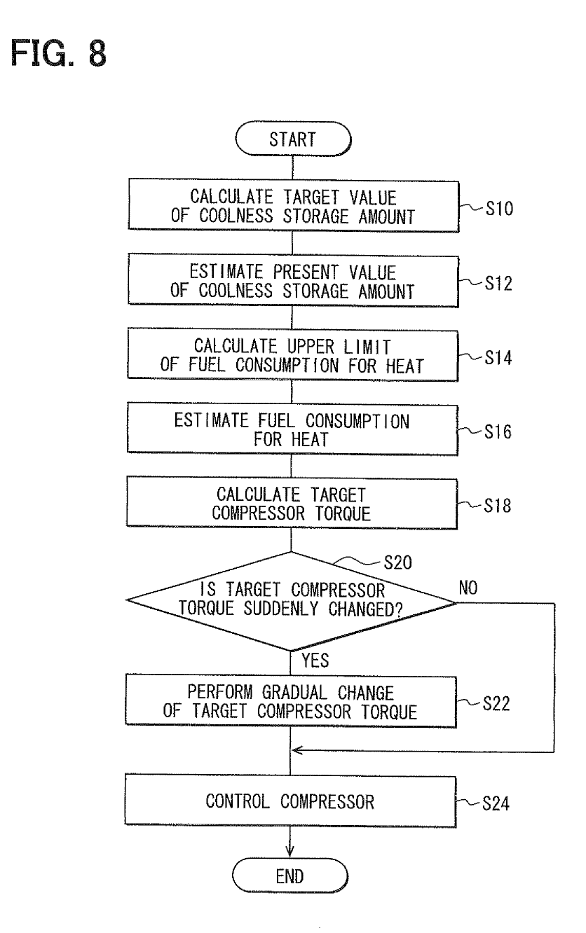

FIG. 8 shows a process to control the fuel consumption for heat. The process is repeatedly performed by the air-conditioning ECU 46 with a predetermined period.

At S10, the target value of coolness storage amount is calculated. At S12, the present value of coolness storage amount is estimated. At S14, the upper limit of fuel consumption for heat is calculated. At S16, the estimation fuel consumption for heat is calculated. S16 may function independently from S10 or S12. At S18, the target compressor torque is calculated.

S20 is performed after completion of S18, so as to judge whether the target compressor torque has a sudden change or not.

When it is judged that the target compressor torque is changed suddenly at S20, S22 is performed so as to gradually change the target compressor torque. Thus, the target compressor torque is gradually changed to a new point, for example, by applying several seconds, so as to avoid drivability lowering.

In a comparison example, if the target compressor torque is changed suddenly, it takes a predetermined time such as several seconds before the actual compressor torque follows the target value. For this reason, if a speed change of the engine torque is higher than a speed change of the compressor torque, a driving torque of the vehicle may become improper, such that there is a possibility that the drivability is lowered. However, due to the gradually changing process of the present embodiment, the drivability can be restricted from being lowered.

When S22 is completed, or when a negative judgment is performed at 520, 524 is performed so as to drive the compressor 20. If the estimation fuel consumption for heat is larger than the upper limit at S18, the target torque is set as 0, and the compressor 20 is stopped.

When S24 is completed, the fuel consumption for heat control process is once ended.

Advantages of the Embodiment Will be Described.

The present value of coolness storage amount is estimated based on the refrigerant flowing amount, the refrigerant temperature history, and the phase of the agent 27. The phase of the agent 27 is estimated based on the coolness storage amount of the evaporator 26 and the temperature of the agent 27.

Therefore, a change of the coolness storage amount can be determined based on the sensible heat or the latent heat. Thus, the present value of coolness storage amount can be accurately estimated.

The target value of coolness storage amount is calculated based on the idle stop standard period, the air-sending amount of the evaporator fan 38, and the temperature difference of passenger compartment or outside air between the target value and the actual value.

Therefore, the target value of coolness storage amount required for a cooling operation while the engine 10 is automatically stopped can be calculated with high precision.

The upper limit of fuel consumption for heat is calculated based on the present time coolness storage amount and the target coolness storage amount. Further, the estimation fuel consumption for heat is calculated by defining the compressor torque to have plural values different from each other. Furthermore, the maximum value of the compressor torque is defined as a target compressor torque in a manner that the estimation fuel consumption for heat becomes equal to or lower than the upper limit.

Therefore, the coolness storage amount of the evaporator 26 required for a cooling operation can be restricted from being shorted, even when the engine 10 is automatically stopped. As a result, a proper cooling control can be performed when the engine 10 is automatically stopped. Moreover, the compressor 20 can be restricted from having too much activation. As a result, the fuel consumption reduction effect of the engine 10 can be restricted from being lowered.

The compressor 20 is controlled in a manner that the discharge capacity of the compressor 20 becomes equal to the maximum capacity at a vehicle slowdown time.

Therefore, the coolness storage amount of the evaporator 26 can be increased. As a result, the fuel consumption reduction effect of the engine 10 can be restricted from being lowered.

The fixed-width dead zone is set for a variation of the target compressor torque.

Therefore, the torque of the engine 10 can be restricted from having variation. As a result, the drivability can be restricted from being lowered.

When it is judged that the target compressor torque is required to have a sudden change, the target compressor torque is made to be gradually changed.

Therefore, the driving torque of the vehicle is restricted from becoming improper, such that the drivability can be restricted from being lowered.

The embodiment may have the following modifications.

The feed-back operation amount of the control valve 20a is not limited to be performed by the proportional integration derivative control based on the deviation between the real compressor torque and the target compressor torque. Alternatively, the feed-back operation amount may be calculated using a proportional control or proportional derivative control.

The compressor 20 is not limited to be the capacity-variable compressor. Alternatively, the compressor 20 may be a capacity-fixed compressor to have a constant discharge capacity. In this case, the compressor 20 has an electromagnetic clutch to transmit (ON) or intercept (OFF) the rotation power of the crankshaft 14 to the drive shaft of the compressor 20. The compressor 20 is turned on if the estimation fuel consumption for heat is equal to or lower than the upper limit.

The compressor torque control is not limited to be performed by using both of the feed-back control and the feed-forward control. Alternatively, only one of the feed-back control and the feed-forward control may be used. Further, for example, a correction amount is assigned to a table in advance based on a deviation between the real compressor torque and the target compressor torque, and the feed-back control amount may be calculated by selecting the correction amount.

The calculation method of the refrigerant flowing amount is not limited to the above method. If the air-conditioning system has a sensor to detect a refrigerant flowing amount of the refrigerating cycle, the refrigerant flowing amount may be calculated based on an output value of the sensor.

The idle stop standard time is not limited to be a fixed value. The idle stop standard time may be changed based on environment information around the vehicle, for example. The environment information may be traffic information transmitted by a navigation system, or may be a detection signal transmitted by a sensor to detect a distance between two vehicles.

Therefore, the idol stop standard time can be set in accordance with a situation around the vehicle, and the target value of coolness storage amount can be computed with high precision. If a switch is arranged in the vehicle to choose driving mode such as eco-mode to give priority to the fuel consumption reduction effect, the idle stop standard time may be set shorter by turning on the switch. Thus, the fuel consumption amount can be further reduced.

The regenerative rate may be corrected based on the environment information. Specifically, the regenerative rate may be increased, as the distance between two vehicles becomes large. The regenerative rate may be decreased, as a distance between a vehicle and a traffic signal becomes short. Therefore, accuracy for predicting the regenerative amount can be raised when the vehicle has a slowdown.

The compressor 20 is not limited to be controlled in a manner that the discharge capacity of the compressor 20 becomes equal to the maximum capacity at a slowdown time. For example, the compressor 20 may be controlled to have a capacity less than the maximum capacity.

The calculation method of the target compressor torque is not limited to the above method. For example, a predetermined compressor torque may be defined as a target compressor torque in a manner that the estimation fuel consumption for heat becomes equal to or lower than the upper limit. The target compressor torque may be set in accordance with the fuel consumption reduction effect and a comfortableness of the cooling operation while the engine 10 is automatically stopped.

For example, the target compressor torque may be calculated based on the present coolness amount and the target coolness amount. Specifically, the target compressor torque may be calculated using PID control based on a difference between the present coolness amount and the target coolness amount.

Further, the target value of coolness storage amount may be fixed. The present coolness storage amount is not limited to have the feed-back control. The target compressor torque may be set as an operation amount necessary for performing open-loop control, in which the actual coolness storage amount is controlled into the target coolness storage amount.

The estimation method of the present value of coolness storage amount is not limited to the above method. The air-conditioning device may further include a second refrigerant temperature sensor to detect a temperature of refrigerant at an outlet side of the evaporator 26.

The present value of coolness storage amount may be estimated based on a variation history of the refrigerant temperature before-and-after passing through the evaporator 26, and the refrigerant flowing amount. In this case, even if the agent 27 has a phase transition, the present value can be accurately estimated without considering the sensible heat and the latent heat of the agent 27. Further, the present value of coolness storage amount may be estimated by using a model in which refrigerant temperature is continuously input.

The temperature of the agent 27 is not limited to be estimated based on the specific heat of the agent 27, the mass of the agent 27 and the last time coolness storage amount. If the air-conditioning device further has a sensor to detect a temperature of the agent 27, the temperature of the agent 27 is estimated based on an output of the sensor.

The calculation method of the target value of coolness storage amount is not limited to the above method. For example, the target value may be calculated based on at least one of the idle stop standard time, the air-sending amount of the fan 38, the target temperature, and the temperature of passenger compartment or outside air. Moreover, for example, the target value may be set based on a cooling load predicted based on season or using area.

The calculation method of the upper limit of fuel consumption for heat is not limited to the above method. For example, the upper limit may be calculated using a map. In the map, the upper limit of fuel consumption for heat is increased as the required coolness storage amount ΔQ is increased. The upper limit may be set as 0 when the required coolness storage amount ΔQ is equal to or lower than 0.

The cooling operation using the air cooled by the stored cold energy is not limited to be performed when the engine 10 is automatically stopped. If the coolness storage amount of the evaporator 26 is larger than the target value, for example, the cooling operation can be performed by auxiliary use of the cold energy stored in the evaporator 26 while the engine 10 is active. The cooling operation can be performed by using only the cold energy stored in the evaporator 26 by stopping the compressor 20 while the engine 10 is active.

The vehicle may not have the idle stop control. In a case where the idle stop control is not performed, if the estimation fuel consumption for heat is larger than the upper limit while the engine 10 is activated, the cooling operation may be performed by using only the cold energy stored in the evaporator 26 by stopping the compressor 20. The cooling load can be calculated using a target time of the cooling operation during which the compressor 20 is predicted to be stopped, in place of the idle stop standard time. The target time is predetermined in accordance with a heat storage capacity of the evaporator 26.

When the fuel consumption for heat is estimated, a compressor torque may be set larger than the value of T necessary for the cooling of the passenger compartment. In this case, if the fuel consumption for heat is larger than the upper limit, the compressor torque may be set as the target torque.

The evaporator 26 may not be integrated with the heat storage portion. The air-conditioning system may further include a heat storage portion having the coolness storage agent 27 separated from the evaporator 26. In this case, the heat storage portion may be arranged between the evaporator 26 and a suction port of the compressor 20. Alternatively, the heat storage portion may be connected parallel with the evaporator 26.

The air-conditioning of the passenger compartment is not limited to the cooling operation. The air-conditioning may be a dehumidification so as to remove fogging for a windshield of the vehicle, for example. In this case, the target value of coolness storage amount can be set based on a heat amount required for the dehumidification.

Such changes and modifications are to be understood as being within the scope of the present invention as defined by the appended claims.

The present value of coolness storage amount is estimated using the refrigerant temperature history. A history of heat amount transferred between refrigerant and the coolness storage agent 27 is obtained, and the estimation can be accurately performed.

The heat expense is a fuel consumption amount of the engine necessary for generating a predetermined heat amount by driving the compressor.

If the fuel consumption amount is increased by the driving of the compressor, the engine has a low thermal efficiency. At this time, the compressor can be restricted from being driven too much.

If the driving torque of the compressor has a variation, the sending amount of compressed refrigerant is varied. In this case, heat amount generated by the refrigerating cycle may have a variation, and the torque or rotation speed of the engine may have a variation. The fuel consumption amount of the engine is varied in accordance with the operation state of the engine such as torque or rotation speed. Therefore, the estimation fuel consumption for heat is varied by a torque variation of the compressor. Thus, the torque of the compressor and the estimation fuel consumption for heat can be related with each other.

The engine is automatically stopped or restarted so as to reduce the fuel consumption of the engine. However, when the engine is automatically stopped, the compressor cannot be activated. Therefore, coolness storing is necessary when the engine is active, so as to perform air-conditioning while the engine is automatically stopped.

What is claimed is:

1. An air-conditioning control device for a vehicle comprising:
an air-conditioner including
a compressor to compress refrigerant, the compressor being driven by an engine of the vehicle, and
a heat storage portion having a coolness storage agent so as to store heat of the refrigerant, a passenger compartment of the vehicle being air-conditioned using air cooled by the heat storage portion when the compressor is stopped;
an estimating portion to estimate a present value of coolness amount stored in the heat storage portion based on a temperature history of the refrigerant; and
a controller to control the compressor so as to store coolness in the heat storage portion based on the estimated present value of coolness amount stored in the heat storage portion.

2. The air-conditioning control device according to claim 1, wherein
the estimating portion determines a phase of the coolness storage agent based on a coolness amount stored in the heat storage portion and a temperature of the coolness storage agent, and
the estimating portion selectively performs estimation of sensible heat or latent heat based on the phase of the agent.

3. The air-conditioning control device according to claim 1, further comprising:
a target coolness amount setting portion to variably set a target value of coolness amount stored in the heat storage portion based on a heat amount required for performing air-conditioning of the passenger compartment when the compressor is stopped, wherein
the controller controls the compressor based on the present value of coolness amount estimated by the estimating portion and the target value of coolness amount set by the setting portion.

4. The air-conditioning control device according to claim 3, further comprising:
a predicting portion to predict an increase value of the coolness amount when the coolness amount is increased by converting a kinetic energy of the vehicle when the vehicle has a slowdown, wherein
the target coolness amount setting portion corrects the target value by subtracting the predicted increase value, and
the controller causes the compressor to be driven when the vehicle has a slowdown.

5. An air-conditioning control device comprising:
an air-conditioner including
a compressor to compress refrigerant, the compressor being driven by an engine of the vehicle, and
a heat storage portion having a coolness storage agent so as to store heat of the refrigerant, a passenger compartment of the vehicle being air-conditioned using air cooled by the heat storage portion when the compressor is stopped;
a predicting portion to predict an increase value of coolness amount stored in the heat storage portion when the coolness amount is increased by converting a kinetic energy of the vehicle in a case where the vehicle has a slowdown;
a target coolness amount setting portion to variably set a target value of the coolness amount stored in the heat storage portion by subtracting the predicted increase value from a heat amount required for performing air-conditioning of the passenger compartment when the compressor is stopped; and
a controller to control the compressor based on the target value, and to cause the compressor to be driven when the vehicle has a slowdown.

6. The air-conditioning control device according to claim 3, wherein
the target coolness amount setting portion sets the target value based on at least one of a temperature related with a temperature of air to be cooled by the heat storage portion, a time period for which the compressor is predicted to be stopped, an amount of air to be sent into the passenger compartment, and a target temperature of the passenger compartment.

7. The air-conditioning control device according to claim 1, further comprising:
an allowable amount setting portion to set an allowable amount of a fuel consumption for heat,
the fuel consumption for heat corresponds to a fuel consumption amount of the engine required for generating a predetermined heat amount by driving the compressor, and
the controller drives the compressor if the fuel consumption for heat is equal to or lower than the allowable amount.

8. The air-conditioning control device according to claim 7, further comprising:
a target torque setting portion to set a target torque of the compressor, wherein
the allowable amount setting portion calculates a plurality of the fuel consumptions for heat by defining the compressor to have a plurality of torques different from each other,
the target torque setting portion sets the target torque based on the calculated fuel consumptions for heat in a manner that the fuel consumption for heat becomes equal to or lower than the allowable amount, and
the controller controls the compressor to have the target torque.

9. The air-conditioning control device according to claim 8, wherein
the target torque setting portion sets a maximum torque as the target torque.

10. The air-conditioning control device according to claim 8, wherein
the controller sets a fixed-width dead zone relative to a variation of the target torque.

11. The air-conditioning control device according to claim 8, wherein
the controller has a feed-forward part to perform a feed-forward control relative to an actual torque of the compressor in accordance with the target torque, and a feed-back part to perform a feed-back control in accordance with a difference between the actual torque and the target torque.

12. The air-conditioning control device according to claim 8, further comprising
a gradually changing portion to gradually change the target torque when the target torque is determined to be changed.

13. The air-conditioning control device according to claim 1, further comprising:
an engine controller to perform an automatic stop or restart of the engine.

14. An air-conditioning control device for a vehicle comprising:
an air-conditioner including
a compressor to compress refrigerant, the compressor being driven by an engine of the vehicle, and
a heat storage portion having a coolness storage agent so as to store heat of the refrigerant, a passenger compartment of the vehicle being air-conditioned using air cooled by the heat storage portion when the compressor is stopped;
an allowable amount setting portion to set an allowable amount of a fuel consumption for heat, the fuel consumption for heat corresponding to a fuel consumption amount of the engine required for generating a predetermined heat amount by driving the compressor; and
a controller to drive the compressor if the fuel consumption for heat is equal to or lower than the allowable amount.
